(19) United States
(12) Patent Application Publication
(10) Pub. No.: US 2026/0095294 A1
(43) Pub. Date: Apr. 2, 2026

(54) ENERGY HARVESTING FROM NEIGHBORING NODES BY ROAMING DEVICES WITHIN A NETWORK

(71) Applicant: Silicon Laboratories Inc., Austin, TX (US)

(72) Inventor: Mustafa Murtaza Shamsi, Bharuch (IN)

(21) Appl. No.: 18/899,063

(22) Filed: Sep. 27, 2024

(51) Int. Cl. H04L 5/00; H02J 50/00; H04W 60/04

(52) U.S. Cl. CPC H04L 5/0055; H02J 50/001; H04W 60/04

(57) ABSTRACT

In a wireless communications network, a mobile node harvests energy from another node of the wireless communications network and stores energy, e.g., to re-charge a battery, thereby extending the amount of time between battery replacements or lifespan of the mobile node. Logic for registration and initiation of an energy harvesting session is included in a gateway node that is accessible to both the mobile node and another node that is configurable as a wireless charger node. The gateway node serves as a central intermediary that enables the mobile node to register once with the gateway node. The mobile node sends the request for the wireless charging session to the gateway node, as needed, and the gateway node assigns another node in the wireless communications network to serve as the wireless charger node based on the location of the mobile node.

### BACKGROUND

### Field of the Invention

This disclosure relates to communications systems in general, and more particularly to networks of wireless communications systems.

### Description of the Related Art

In general, wireless communications devices are being deployed in high numbers in wireless networks, e.g., Internet of Things (IoT) systems. A typical IoT device is battery-powered, includes sensors, processing circuits, and software, and is capable of exchanging data with other devices and systems using a communications protocol. An IoT device may be inaccessible for periodic maintenance, e.g., to replace or charge a battery. In addition, periodic battery replacement can be detrimental to the environment. Therefore, rather than include a conventional battery, some IoT devices include an energy harvesting system to harvest energy from an ambient source of energy, e.g., solar, thermal, or kinetic energy. An energy harvesting system can reduce maintenance costs due to battery replacement and may increase the lifespan of an associated battery-powered device. However, an IoT device may not be stationary. For example, smart watches, medical fitness bands, medical assistive devices, ear implants, and pacemakers, are wirelessly connected devices that might rely on energy harvesting as a source of energy. As a mobile IoT device moves, repeated scanning and pairing with an RF charger device in the wireless network may consume substantial amounts of energy that exceed the amount of energy that would be harvested from an RF charger device. Accordingly, new techniques for harvesting energy by roaming IoT devices are desired.

### SUMMARY OF EMBODIMENTS OF THE INVENTION

In at least one embodiment, a method for harvesting energy in a network of nodes includes transmitting, by a mobile node in the network of nodes, a request for a wireless charging session. The request includes location information for the mobile node. The method includes receiving from a gateway node in the network of nodes in response to the request, a wireless charging session response including an assignment of a second node in the network of nodes to be a wireless charger node. The second node is proximate to the mobile node and is available for the wireless charging session. The request may further include a target amount of energy to be harvested. The assignment of the second node may be based on the location information and the target amount of energy to be harvested. The assignment may include a duration of a wireless charging session and a start time. The method may include selecting, by the gateway node, the second node of the network of nodes to be the wireless charger node based on the location information for the mobile node. The method may include sending the wireless charging session response including the assignment. The method may include initiating the wireless charging session between the second node and the mobile node in response to the wireless charging session response. The method may include transmitting, by the mobile node, a second request for a second wireless charging session. The second request may include updated location information for the mobile node. The method may include receiving from the gateway node in response to the second request, a second wireless charging session response including a second assignment of a third node in the network of nodes as the wireless charger node. The third node may be closer to the mobile node than the second node based on the updated location information.

In at least one embodiment, a network of wireless nodes includes a gateway node having a radio frequency transceiver configured to transmit and receive radio frequency signals. The gateway node includes processing circuitry configured to execute an energy harvesting service operable to: register a plurality of wireless nodes, and assign a first node of the plurality of wireless nodes as a wireless charger node for a wireless charging session in response to a request for the wireless charging session from a second node of the plurality of wireless nodes and based on a location of the second node relative to a corresponding second location for each node of the plurality of wireless nodes, the second node being a mobile node. The second node may include a second radio frequency transceiver configured to transmit and receive radio frequency signals and second processing circuitry configured to execute a second energy harvesting service operable to: generate the request for the wireless charging session. The request may include information regarding the location of the second node. The gateway node may store registration information for each node of the plurality of wireless nodes, the registration information including identification information and location information. The energy harvesting service may be further configured to schedule the wireless charging session based on an estimate of energy to be harvested by the second node during the wireless charging session and based on an indication of available energy of each of the plurality of wireless nodes.

In at least one embodiment, a method for harvesting energy in a network of nodes includes receiving, by a gateway node of the network of nodes, a request for a wireless charging session from a mobile node of the network of nodes. The request includes location information for the mobile node. The method includes, in response to the request, transmitting an assignment of a second node in the network of nodes as a wireless charger node based on the location information and proximity of the mobile node to the second node. The assignment may include a duration of a wireless charging session and a start time. The assignment may be further based on a target amount of energy to be harvested by the mobile node. The method may include receiving, by the gateway node, a second request for a second wireless charging session from the mobile node. The second request may include updated location information for the mobile node. The method may include transmitting by the gateway node in response to the second request, a second wireless charging session response including a second assignment of a third node in the network of nodes as the wireless charger node. The third node may be closer to the mobile node than the second node based on the updated location information.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a functional block diagram of an exemplary wireless network including a mobile node.

FIG. 2 illustrates a functional block diagram of an exemplary wireless network including a mobile node and a gateway node consistent with at least one embodiment of the invention.

FIG. 3 illustrates a functional block diagram of an exemplary wireless node of FIG. 2.

FIG. 4A illustrates an exemplary information and control flow of a power management unit of the wireless node of FIG. 3 consistent with at least one embodiment of the invention.

FIG. 4B illustrates an exemplary information and control flow of a gateway node of FIG. 3 consistent with at least one embodiment of the invention.

FIG. 4C illustrates an exemplary information and control flow of a wireless charger node of FIG. 3 consistent with at least one embodiment of the invention.

FIG. 5A illustrates an exemplary message exchange between a gateway node and a mobile node of the network of FIG. 2 consistent with at least one embodiment of the invention.

FIG. 5B illustrates an exemplary message exchange between a gateway node and a wireless charger node of the network of FIG. 2 consistent with at least one embodiment of the invention.

FIG. 6 illustrates a functional block diagram of exemplary nodes of the network of FIG. 2.

FIG. 7 illustrates a functional block diagram of a protocol stack executing on a node of FIG. 6.

FIG. 8 illustrates a functional block diagram of an embedded software stack executing on a wireless node of FIG. 6.

The use of the same reference symbols in different drawings indicates similar or identical items.

### DETAILED DESCRIPTION

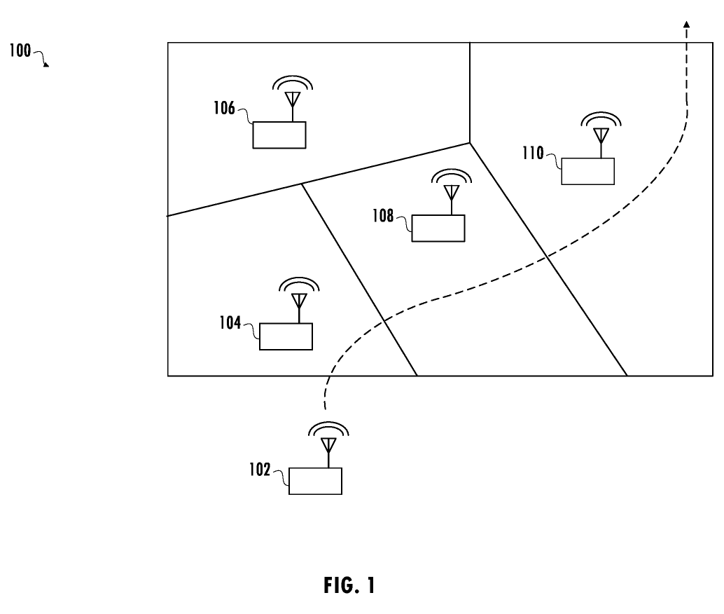

FIG. 1 illustrates a trajectory of mobile node 102 in mesh network 100 including nodes 102, 104, 106, 108, and 110. The position of mobile node 102 with respect to other nodes of mesh network 100 varies in time. Mobile node 102 seeks to initiate a wireless charging session and nodes 104, 106, 108, and 110 are capable of serving as wireless charger nodes. Techniques described in U.S. Patent Application Number 18/374,411, entitled “Method to Harvest Energy from Neighboring Nodes Within a Communications Network,” naming Mustafa Murtaza Shamsi as inventor, filed on September 28, 2023, which application is incorporated herein by reference, require that mobile node 102 scan, register, and initiate a harvesting session with node 104, with node 108, and then again with node 110, as mobile node 102 traverses regions proximate to each of those nodes. Those operations consume substantial amounts of energy that may even exceed the amount of energy that would be harvested from those nodes.

In a wireless communications network (e.g., an IoT network), a mobile node (e.g., an IoT node) harvests energy from another node of the wireless communications network and stores energy, e.g., to charge or recharge a battery or other storage device, thereby extending the amount of time between battery replacements or lifespan of the mobile node. An exemplary energy harvesting technique considers the current location of the mobile node and the possibility of roaming by the mobile node. Logic for registration and initiation of an energy harvesting session is included in a gateway node that is accessible to both the mobile node and another node configured as a wireless charger node. The gateway node serves as a central intermediary that enables the mobile node to register with the gateway node. The gateway node maps a request from the mobile node for a wireless charging session with another node of the wireless communications network configured as a wireless charger node. The mobile node sends one or more requests for one or more wireless charging sessions to the gateway node, as needed, and the gateway node selects and assigns another node in the wireless communications network to serve as the wireless charger node based on the location of the mobile node.

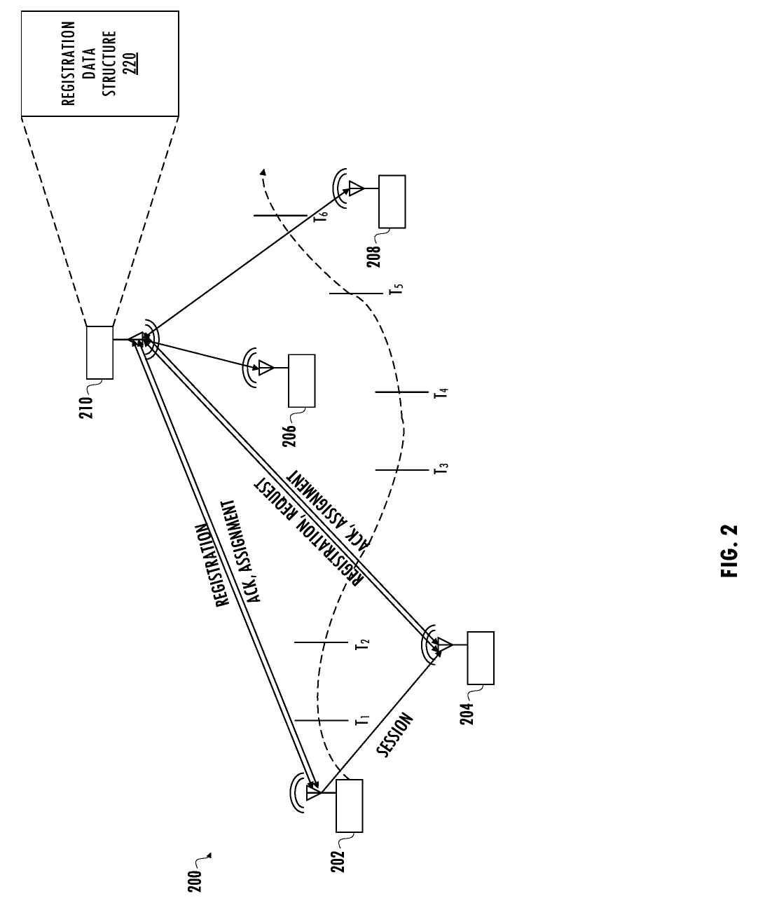

Referring to FIG. 2, an embodiment of a wireless communications network includes a gateway node to manage wireless charging sessions, which reduces the scan, registration, and initiation communications for wireless charging sessions, thereby reducing power consumption and messaging traffic associated with the wireless charging sessions. Mesh network 200 is implemented as a mesh network of nodes, e.g., nodes including wireless communications interfaces compliant with the Bluetooth® Low Energy (BLE) communications protocol or the BLE High Data Throughput (BLE HDT) communications protocol designed for low power and low latency applications. Nodes 204, 206, 208, and 210 of mesh network 200 may include different types of devices. At least some of the devices may be IoT devices, e.g., sensors, monitors, actuators, automation devices, lighting devices, or other devices. For example, mesh network 200 may be a home automation IoT network, a building automation network, such as for an industrial or commercial location, a smart network, e.g., a smart city network, a smart building or home network, a smart lighting network, or other network. Unlike a conventional computer network where each device has a similar set of capabilities, mesh network 200 can be implemented with a collection of devices having different capabilities, and which communicate with each other using one or more wireless communication channels.

In at least one embodiment of mesh network 200, nodes 204, 206, 208, and 210 may be powered in different ways, e.g., line-powered, non-rechargeable battery-powered, and ambient energy source-powered devices (e.g., solar/wind/radio frequency (RF)/etc.). Nodes 204, 206, 208, and 210 can include line-powered meters (e.g., electric meters), wireless routers, LED lamps, battery-powered smart doorknobs, cameras, smartwatches, home automation devices, and solar-powered LED lamps, or other energy harvesting devices. In an embodiment, mobile node 202 uses one or more ambient sources of energy, e.g., solar, wind, hydroelectric, or other ambient energy source. In an embodiment, mobile node 202 receives at least some energy via RF communications.

Mesh network 200 includes gateway node 210, which centralizes scan, registration, and assignment of nodes to wireless charging sessions between corresponding mobile nodes and wireless charger nodes. Gateway node 210 serves as an intermediary that coordinates a request for a wireless charging session from mobile node 202 and selects an appropriate node of nodes 204, 206, 208, and 210 to serve as the wireless charger node for the wireless charging session. The scanning, registration and the initiation functions are not performed by mobile node 202 but are instead performed by gateway node 210. Gateway node 210 is accessible to (i.e., is within range for wireless communications with) mobile node 202 and to nodes 204, 206, and 208. Gateway node 210 maps the request for a wireless charging session to an available wireless charger node to charge mobile node 202 when stationary. Times T₁ - T₆ represent intervals where mobile node 202 is stationary at a location on the trajectory of mobile node 202 and participates in a corresponding wireless charging session. The interval that mobile node 202 spends at each of these locations has a variable duration. As mobile node 202 navigates, its proximity to available nodes that are capable of serving as a wireless charger node changes. In an embodiment of mesh network 200, all nodes of mesh network 200 are capable of establishing a 2-way communication with gateway node 210.

In an embodiment, gateway node 210 is a remote cloud server that receives line power, but in other embodiments, gateway node 210 is another type of wireless communications node that is powered using a storage device. In an embodiment, gateway node 210 is a mesh device with long range communication capabilities. Mobile node 202 and nodes 204, 206, and 208 each register with gateway node 210. In some embodiments, a stationary node registers with gateway node 210 at installation and setup and a mobile node registers with gateway node 210 after a determination to initiate a charging session. In some embodiments, mobile nodes register with gateway node 210 in response to moving out of a communications range of another gateway node and being in a communications range of gateway node 210. As a mobile node roams across various mesh networks, registration policies vary according to policies of corresponding mesh networks in the communications range of the mobile node. Gateway node 210 maintains information for each node that has successfully authenticated its identity and registered with gateway node 210. For example, gateway node 210 may include a data structure stored in memory that includes, for each registered node, status bits encoding one or more of the following: a node identifier, a last known location of the node, a last known energy level of the node, an estimated amount of time to be at the last known location, availability of the device to serve as a wireless charger node, or other information. These entries may be updated after registration and completion of authentication (e.g., concurrently with sending an acknowledgment to the mobile node). These entries may be removed from the data structure in response to a node deregistering itself from the gateway node, e.g., when the node goes offline. In at least one embodiment, an Application Programming Interface (API) call adds, updates, or removes an entry in the data structure.

In at least one embodiment, gateway node 210 includes a data structure indicating status information (e.g., an online or offline indicator) for all nodes in the network that may potentially serve as a wireless charger node. De-registration deletes an entry from the data structure and is initiated when a wireless charger node ceases to be available for an energy harvesting session, e.g., due to physical device replacement, hardware failure, or firmware update that modifies the behavior or capabilities of the node. In an embodiment, changes to the data structure are performed manually or by gateway node 210 in response to messages received from a node (e.g., a de-registration message that includes a node identifier and an opcode indicating the change to be made). In an embodiment, gateway node 210 removes a node from the data structure in response to the node being offline or non-responsive for a predetermined amount of time. In an embodiment, the data structure also includes entries for mobile nodes and those entries store information that is the same as, or different from, stored information for wireless charger nodes. In an embodiment, a mobile node does not de-register when leaving communications range of a gateway node and the gateway node discards the entry for a mobile node for which it has not received a communication for a predetermined amount of time.

In at least one embodiment, each time mobile node 202 intends to initiate a wireless charging session, node 202 sends a message requesting an energy harvesting session to gateway node 210. The request message includes a unique identifier, the current position, current battery level, or other information associated with mobile node 202. Gateway node 210 determines whether the requesting node is registered by comparing a unique node identifier included in the request message to the node identifiers stored in the data structure. Gateway node 202 ignores any request from an unregistered node. The requesting device (e.g., mobile node 202) may determine its current position and provides absolute coordinates or a relative location by using a by using a Global Positioning System (GPS) or relative positioning system as defined by the mesh network. Gateway node 210 may use this location information to select the wireless charger node from multiple registered nodes. For example, gateway node 210 selects the registered node that is closest to the requesting node to be the wireless charger node.

In at least one embodiment, request message also includes a target amount of energy to be harvested by mobile node 202 during a requested wireless charging session. For example, if mobile node 202 initiates a wireless charging session in response to detecting a low battery level, mobile node 202 determines how much energy is needed to restore the battery level to a predetermined battery level. Gateway node 210 may use this information to select a wireless charger node from the registered nodes if multiple nodes are registered or multiple nodes are in a predetermined range proximate to mobile node 202 and are available to charge mobile node 202. For example, gateway node 210 may select a registered node that is closest to mobile node 202 or may select a registered node that is farther away from mobile node 202 than other registered nodes but has more excess energy, has a higher estimated speed of energy transfer, or expected duration at a current location. or other criteria as compared to other registered nodes for charging mobile node 202 to the predetermined battery level.

In at least one embodiment, mobile node 202 only harvests energy when stationary and the request message includes an estimate of the amount of time that mobile node 202 expects to spend at the current location. The estimated amount of time at the current location may be used by gateway node 210 to select as a charging node another node of the network that will be proximate to mobile node 202 for at least that estimated time. If the node that is closest to mobile node 202 will not be in its current location for at least a predetermined amount of time sufficient to charge mobile node 202 to a suitable level, then gateway node 210 may select another node that is proximate to mobile node 202 to serve as the wireless charger node.

In response to receiving a request for a wireless charging session from mobile node 202, gateway node 210 determines whether a registered node that is suitable for serve as a wireless charger node is in the vicinity of mobile node 202. If a registered node that is suitable for serving as a wireless charger node is in the vicinity of mobile node 202, then gateway node 210 selects that node to serve as the wireless charger node and sends a wireless charging session initiation message to the selected node. In response to the initiation message, which may include an indication of a predetermined interval, the selected node establishes a wireless charging session with mobile node 202 for the predetermined interval or a fixed interval. In at least one embodiment, gateway node 210 responds to mobile node 202 with a status message indicating whether a node is assigned as an energy harvesting node and identifies that node, if any, and any associated duration of the predetermined interval of the energy harvesting session. In at least one embodiment, gateway node 210 broadcasts a message for initiating a wireless charging session that is received by node 204, i.e., the node selected to be the wireless charger node, and mobile node 202, which infers relevant information from the initiation message. In at least one embodiment, where no nodes are selected to be a wireless charger node, no initiation message is sent by gateway node 210 and gateway node 210 sends a status message to mobile node 202 to indicate a failure in assigning a wireless charger node. In response to an event (e.g., movement of mobile node 202), mobile node 202 terminates the wireless charging session before expiration of the predetermined interval (i.e., abandons a request or wireless charging session). In at least one embodiment, mobile node 202 terminates the wireless charging session by directly sending a message, or by indirectly sending a message via gateway node 210, to the wireless charger node. That message includes information for terminating the wireless charging session, e.g., an identifier for the mobile node, a unique identifier of the wireless charging session, a command code indicating termination of the wireless charging session, or a reason for termination.

In at least one embodiment, gateway node 210 maintains a pre-defined database of the distribution of the wireless charger nodes to speed up the process of responding to requests from mobile nodes. In an embodiment, gateway node 210 queries each registered node for information or logs information received in messages broadcast by each registered node. In at least one embodiment of network 200, only stationary nodes share information with gateway node 210 to reduce the number of wireless data transfers needed to build a database. In at least one embodiment, the database is distributed across network 200 and each stationary device stores a database of the wireless charger nodes in its own vicinity. In this embodiment, gateway node 210 has knowledge of stationary nodes or line-powered nodes and maps an incoming wireless charging request from the mobile node to a stationary node or line-powered node, which selects the node to serve as a wireless charger node and responds to the mobile node via gateway node 210.

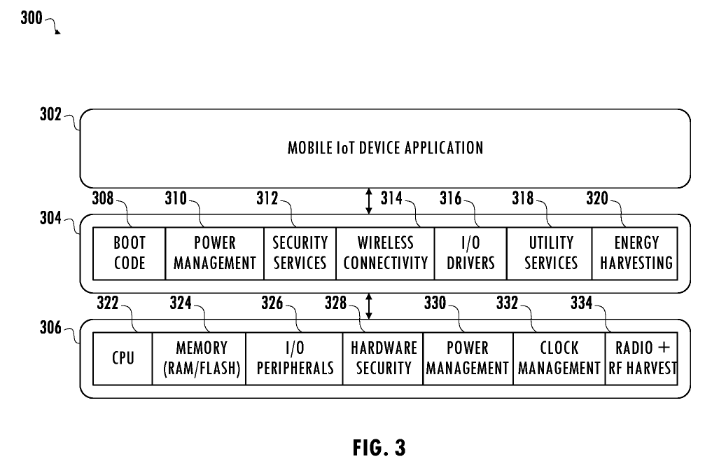

Referring to FIG. 3, in at least one embodiment of a wireless communications network, each node includes hardware 306 and software or firmware components 304. For example, software or firmware 304, which may be stored in memory 324 (which may be implemented as a combination of RAM and flash memory) and executes on Central Processing Unit (CPU) 322 and other circuitry of a node, includes boot code 308, power management services 310, security services 312, I/O drivers 316, utilities 318, and energy harvesting services 320, which includes at least a software service that interacts with power management unit 310, wireless connectivity services 314, and security services 312 to register the node with a gateway node in the network to enable wireless charging sessions. In an embodiment, the registration at the gateway node indicates that node 300 is an energy harvesting node. In at least one embodiment, node 300 registers with the gateway node as an energy charger node.

In an embodiment, radio and RF harvesting hardware 334 include a wireless transceiver and impedance matching circuit (e.g., an L, T, or Pi network) and rectifying circuitry (e.g., half-wave, full-wave, or bridge RF-DC rectifying circuit) that converts RF radiation into electrical energy and has gain, RF-DC power conversion efficiency, a number of stages, a rectifier configuration, and sensitivity suitable for the wireless charging application. Radio and RF harvesting hardware 334 is configured to harvest energy from packets wirelessly received from an associated wireless charger node and stores that energy in an energy storage element. Other hardware components of a node include CPU 322, memory 324, I/O peripherals 326, security hardware 328, power management unit 330, and clock management unit 332. Although shown with limited components, in other embodiments an integrated circuit product may include additional or different components. An application layer includes one or more mobile device applications that interacts with software or firmware 304 and execute on the hardware 306 of node 300.

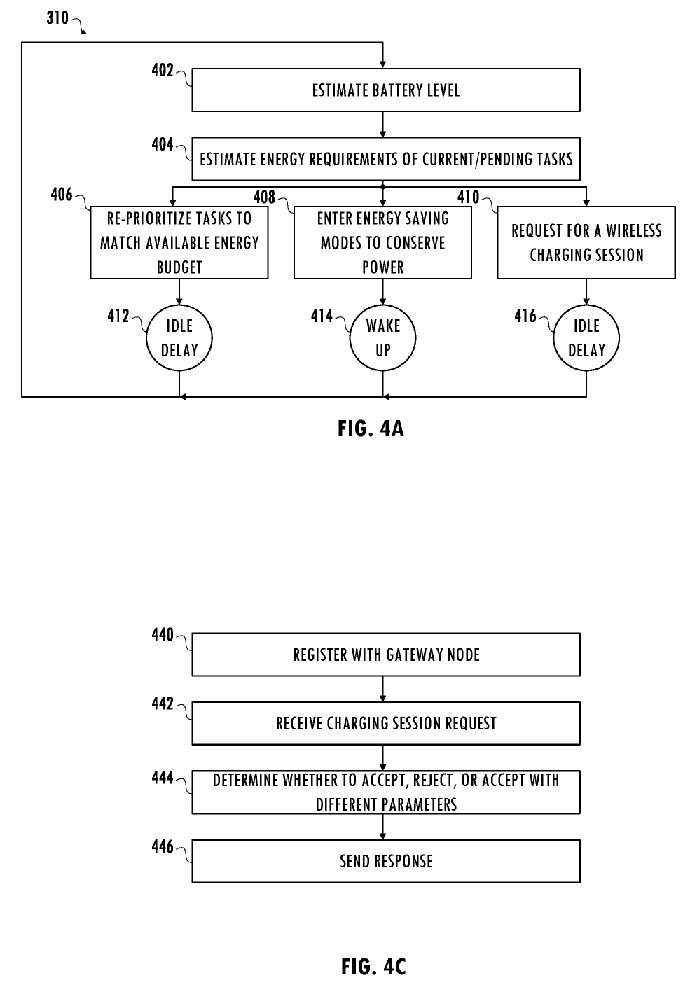

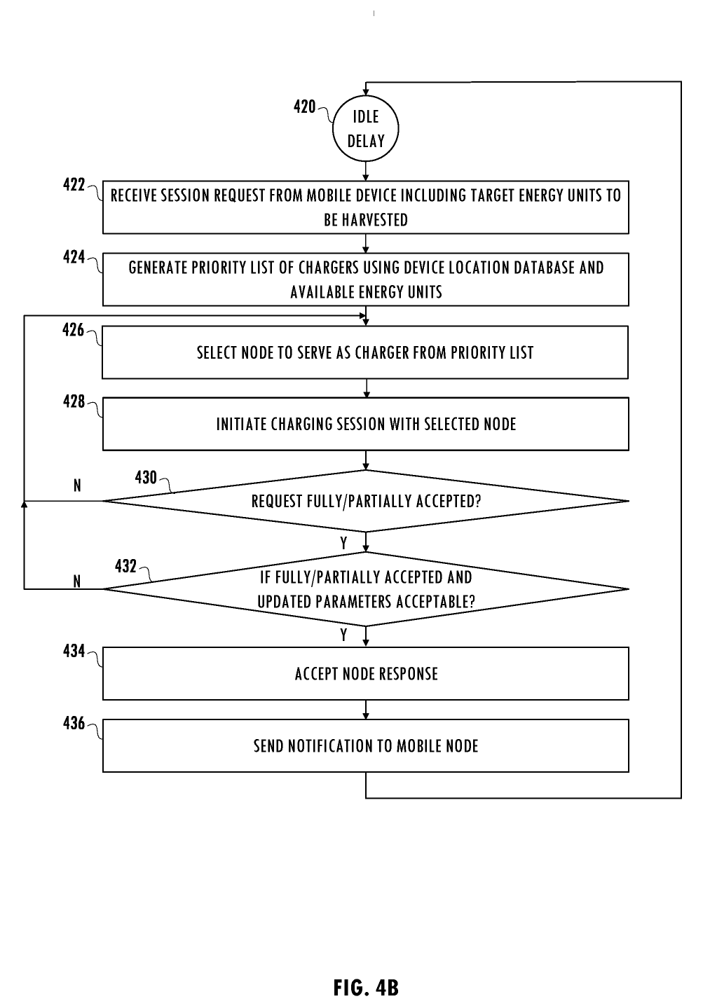

In an embodiment, node 300 registers with a gateway node and indicates that node 300 is an energy harvesting node. In at least one embodiment, energy harvesting software 320 and power management unit 310 configure node 300 in different energy modes to help conserve power. Referring to FIGS. 3 and 4A, in an embodiment, power management unit 310 estimates the battery level of node 300 (402) and estimates the energy requirements of node 300 (404). In an embodiment, node 300 uses different energy modes to conserve power. For example, power management unit 310 re-prioritizes tasks to match the available energy budget (406). After reprioritizing tasks, the power management unit idles to introduce a delay (412) before re-estimating the battery level. In an embodiment, power management unit 310 powers down parts of node 300 that are not in use (408) and wakes up those disabled parts of node 300 when needed (e.g., in response to an event) (414). In an embodiment, power management unit 310 requests a wireless charging session, as needed (410). After a wireless charging session, power management unit 310 enters an idle mode to introduce a delay (416) before reestimating the battery level.

Referring to FIGS. 3 and 4B, in an embodiment, energy harvesting service 320 or other software of gateway node 210 configures gateway node 210 in an idle mode or other mode (420) during which gateway node 210 receives a session request from a mobile node (422). Gateway node 210 generates a priority list of nodes that can serve as wireless chargers using information in the session request (e.g., target energy units to be harvested) and information stored in a database, e.g., device location or available energy units (424). In at least one embodiment, gateway node 210 allocates higher priority to nodes that have greater energy units available or nodes that are closer to the mobile node. Gateway node 210 selects a node to serve as the wireless charger node from the priority list (426). If no node is available to serve as a wireless charger node, then gateway node 210 sends a status message indicative thereof and returns to the idle state. Otherwise, gateway node 210 initiates a wireless charging session between the mobile node and the node selected to serve as the wireless charger node (428). If the request is rejected by the node selected to serve as the wireless charger node (430), then gateway node 210 selects another node to serve as the wireless charger node (426). If the request is not fully accepted or is partially accepted and the updated parameters are not acceptable (432), then gateway node 210 selects another node to serve as the wireless charger node (426). If the request is fully accepted or is partially accepted and the updated parameters are acceptable (432), then gateway node 210 accepts a node response from the wireless charger node (434) and sends a notification to the mobile node (436).

Referring to FIGS. 3 and 4C, in an embodiment, energy harvesting service 320 or other software of a node causes the node to register with gateway node 210 as a possible wireless charging node (440). The node receives a request for a wireless charging session from gateway node 210 (442) and determines whether to accept, reject, or accept with different parameters the request for a wireless charging session (444). The node sends a corresponding response to gateway node 210 (446), which in some embodiments is followed by an acceptance of that response by gateway node 210 and a corresponding acknowledgment from the node. Various embodiments of nodes in a network will have different control sequences or implementations of power management unit 310.

Referring back to FIG. 3, wireless connectivity services 314 enables node 300 to wirelessly transmit and receive data. In an embodiment, the wireless connectivity services 314 includes a physical radio module and associated software that is required to transmit/receive data using the physical radio. Embodiments of wireless connectivity services 314 also include capabilities that allow node 300 to compute co-ordinates for the location of node 300. In at least one embodiment, wireless connectivity services 314 includes a GPS module that estimates the position of node 300 and that runs as a separate service in the application layer. Security services 312 performs data encryption/authentication and device authentication requirements of node 300.

Energy harvesting service 320 causes a mobile node to request a charging session when appropriate, e.g., by configuring node 300 to send a wireless charging session request to a gateway node. In an embodiment, energy harvesting service 320 triggers a mobile node to request a charging session based on a battery level and a target battery level when the device is at rest. If authorization and registration of the mobile node succeeds, then the mobile node is authorized to request charging sessions so long as the node travels within the communications range of gateway node 210. If gateway node 210 is offline, charging requests may be resent while waiting for a valid response from gateway node 210 so that the remaining nodes can determine next steps. In at least one embodiment, the network has redundancy to manage node failure and a redundant gateway node responds to re-sent messages or new registration requests. In at least one embodiment, while gateway node 210 is offline, nodes that are already registered and are stationary since the last request for a wireless charging session send a request for wireless charging session directly to a previously assigned wireless charger node.

In at least one embodiment, a valid response is a message indicating a valid status/error response corresponding to the request. In at least one embodiment, a valid response includes a code identifying a selected wireless charging device and associated information about the selected wireless charging device. The mobile node uses that information to directly interact with the selected wireless charging device, thereby reducing network traffic that goes back and forth between network devices and gateway node 210. In at least one embodiment, a valid response that includes details of the wireless charging session is broadcast and shared with the mobile node and the wireless charger node.

In at least one embodiment, details of the wireless charger node are not shared but the predetermined duration of the wireless charging session and a start time are conveyed to the requesting node to assist the mobile node in preparation for the wireless charging session. Other information may be included in a valid response. In at least one embodiment of a mobile node, while requesting a charging session, the energy harvesting service assesses the mobile node’s energy levels to understand if the mobile node has enough energy to request a wireless charging session and then later process a response received from a gateway node and a wireless charger node.

In at least one embodiment, a gateway node receives requests from a mobile node and maps the mobile node to an available possible wireless charger node in the wireless communications network. The gateway node maps mobile nodes based on the location of the mobile node and the availability of wireless charger nodes in the vicinity (e.g., based on relative proximity to the mobile node, stored energy level, or other characteristic of the wireless charger nodes). In an embodiment of a network, relative proximity to the mobile node of registered wireless charger nodes is identified in a data structure. In other embodiments, registered wireless charger nodes are assigned based on timeslots in a day. Each day is divided into N timeslots, and each timeslot is associated with a list of wireless charger nodes that are available in that timeslot. Whenever a mobile node requests a wireless charging session, the gateway node refers to the timeslot(s) that corresponds to the time of the wireless charging session request and then locates the wireless charger node nearest to the requesting mobile node.

In at least one embodiment of a wireless communications network, a node determines whether it can serve as a wireless charger node. The node issues a request for authentication with the gateway node and, if it is able to serve as a wireless charger node, waits for an assignment of a wireless charging session. The wireless charger node services a wireless charging session (e.g., based on the ability of the wireless charger node). The wireless node continues to wait for assignment of a wireless charging session or goes offline. If the wireless node goes offline it deregisters with the gateway node.

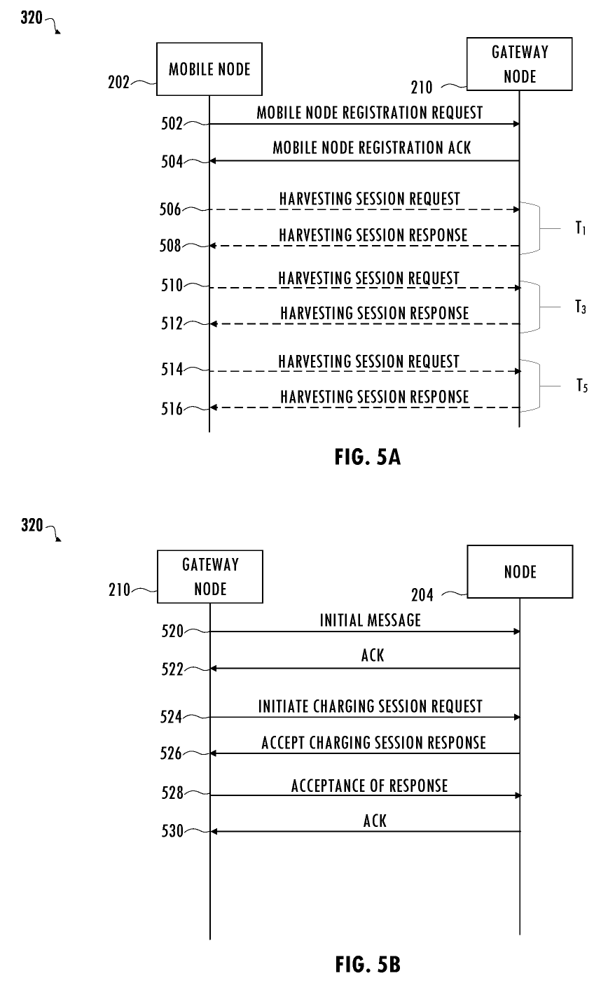

In at least one embodiment, the energy harvesting services configures the corresponding node (which may be a mobile node or a gateway node) to perform the corresponding sequences of FIG. 5A. For example, energy harvesting service 320 causes mobile node 202 to register with gateway node 210 as a one-time activity or mobile node 202 registers with gateway node 210 as a one-time activity when the device enters a specific network (502). Gateway node 210 sends an acknowledgement message to mobile node 202 (504). At time instance T1, mobile node 202 sends a harvesting session request indicating a location (506) and gateway device 210 sends a harvesting session response to the mobile node granting the harvesting session while mobile node 202 is stationary at that location (508). At time instance T2, mobile node 202 may have an updated location or an additional need for energy harvesting and sends another harvesting session request indicating the updated location or updated energy harvesting target (510). Gateway device 210 sends a harvesting session response to the mobile node granting the harvesting session while mobile node 202 is stationary at that updated location (512). At time instance T3, mobile node 202 may have a further updated location or a further additional need for energy harvesting and sends another harvesting session request indicating the updated location or updated energy harvesting target (514). Gateway device 210 sends a harvesting session response to the mobile node 202 granting the harvesting session while mobile node 202 is stationary at that updated location (516).

In at least one embodiment, an energy harvesting service configures the corresponding node (which may be a mobile node or a gateway node) to perform the corresponding sequences of FIG. 5B. For example, energy harvesting service 320 causes gateway node 210 to send an initial message (e.g., ping) to node 204 to determine whether node 204 is online (520). Node 204 sends an acknowledgement to gateway node 210, which updates a stored status of node 204 as being online (522). Gateway node 210 sends a request message to node 204 to initiate a wireless charging session (524). Node 204 evaluates its battery level and the requested duration of the charging session, and determines the feasibility of a wireless charging session with the requested parameters or updated parameters. Node 204 sends a response message accepting the charging session and, in some embodiments, accepts the charging session with updated parameters (526). Gateway node 210 accepts the response indicating a confirmation of any updated parameters (528). Node 204 acknowledges the acceptance of updated parameters (530). Gateway node 210 sends a notification message to the mobile node that requested the wireless charging session. The messaging sequences of FIGS. 5A and 5B are exemplary only and other embodiments of energy harvesting services 320 and nodes in a network will result in different messaging sequences.

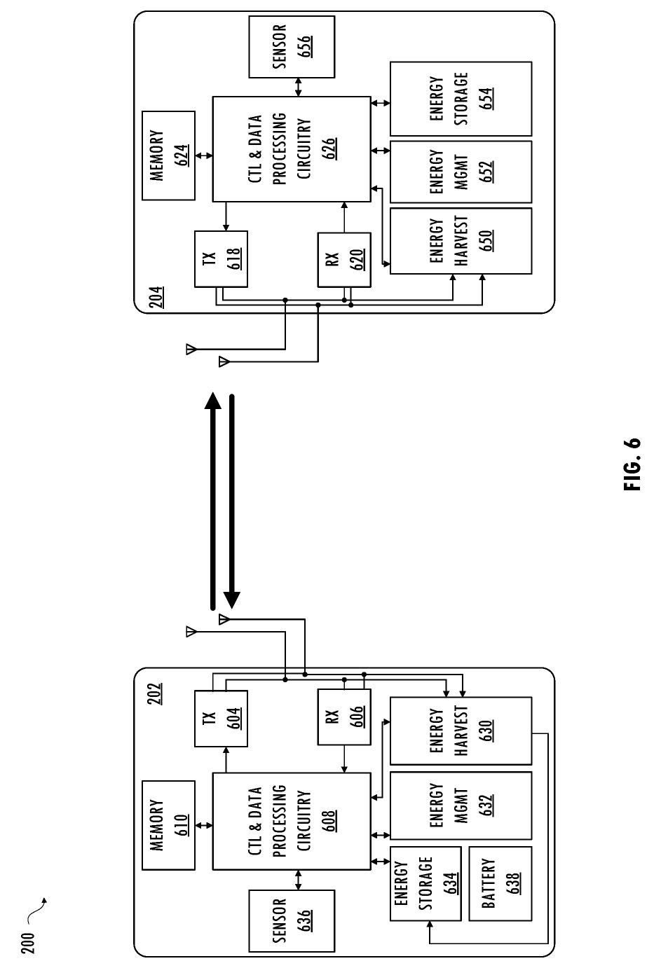

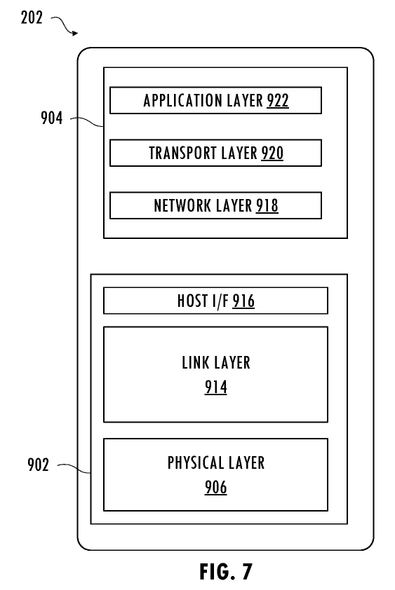

Referring to FIG. 6, in at least one embodiment, network 100 includes mobile node 202 and node 204, which include wireless communications interfaces compliant with the Bluetooth® Low Energy (BLE) communications protocol or the BLE High Data Throughput (BLE HDT) communications protocol designed for low power and low latency applications. Mobile node 202 includes transmitter 604, receiver 606, control & data processing circuitry 608, and memory 610. Node 204 includes transmitter 618, receiver 620, control & data processing circuitry 626, and memory 624. Although mobile node 202 and node 204 are illustrated as each including only one transmitter, one receiver, and two antennas, in other embodiments of network 200, mobile node 202 or node 204 includes multiple transmitters, multiple receivers, additional antennas, or a single antenna with internal circuitry selection or radio frequency switches. Network 200 can communicate information using a predetermined wireless communications protocol, e.g., data using BLE communications protocol or BLE HDT communications protocol. However, in other embodiments, network 100 can transmit and receive data compliant with other wireless communications protocols.

In an embodiment of network 200, mobile node 202 is configured as an energy harvesting node and node 204 is configured as a wireless charger node. In an embodiment, node 202 includes sensor 636, energy harvesting circuit 630, energy management unit 632, energy storage 634, and battery 638, and node 118 includes sensor 656, energy harvesting circuit 650, energy management unit 652, and energy storage 654. In at least one embodiment, sensor 656 includes an application-specific sensor, e.g., a sensor to monitor ambient light in a smart light-emitting diode (LED) application or a passive infrared sensor (PIR) in a smart camera application. In at least one embodiment, energy harvesting circuit 630 includes an impedance matching circuit (e.g., an L, T, or Pi network) and a rectifying circuitry (e.g., half-wave, full-wave, or bridge RF-DC rectifying circuit) that converts RF radiation into electrical energy and has gain, RF-DC power conversion efficiency, a number of stages, rectifier configuration, and sensitivity suitable for a target IoT application. Energy harvesting circuit 630 is configured to harvest energy from packets wirelessly received from a node assigned to be a wireless charger node and stores that energy in energy storage 634. In an embodiment, energy storage 634 is a rechargeable battery or super capacitor.

In an embodiment, energy management unit 632 includes a combination of hardware and software that determines a power budget of node 202 and manages the energy harvesting operations of node 202 based on that power budget. In an embodiment, energy management unit 632 measures the energy level of battery 638, forecasts energy requirements of node 202, interfaces with energy harvesting circuit 630, and determines the current energy level of node 202. In some embodiments, energy management unit 632 implements energy harvesting models that predict the amount of energy that needs to be harvested. In at least one embodiment, energy management unit 632 estimates an power consumption of a wireless charging session and proceeds to request the wireless charging session if the estimate is less than an estimated amount of energy to be harvested and if an estimate of power consumption of the wireless charging session does not exceed a threshold for network congestion that substantially impacts data transmission. In at least one embodiment, energy management unit 632 incorporates other functions (e.g., functions described with reference to energy management unit 652).

In at least one embodiment, node 204 is line powered. In other embodiments, rather than being line-powered, node 204 is battery powered and includes energy storage circuit 654. When node 208 is configured as an energy harvesting node, energy harvesting circuit 650 harvests energy from an assigned wireless charger node and stores that energy in energy storage 654. Energy management unit 652 determines the power budget of node 204 and availability as a wireless charger node. In an embodiment, energy management unit 252 includes hardware and software that monitors the energy usage of node 204 and the strength of the associated energy source (e.g., power-supply node coupled to a battery or other power source). Energy management unit 652 determines whether node 204 can serve as a wireless charger node. For example, if node 204 is line-powered, it is considered to have an infinite source of energy as compared to a battery-powered device and can always serve as a wireless charger node. If node 204 is battery-powered or relies on another source of energy, energy management unit 652 determines whether a stored energy level is sufficient for sharing energy with other nodes. Energy management unit 652 also determines the time periods during which node 204 can serve as a wireless charger. For example, a line-powered device could serve as a wireless charger node at any time. In contrast, a solar powered LED lamp could serve as a wireless charger node only during its active charging period, e.g., during daylight hours.

In addition, energy management unit 652 determines whether node 204 requests a wireless charging session. For example, if node 204 has stored energy that is less than a predetermined threshold amount of energy, it may benefit from harvesting energy from a neighboring wireless charger node to avoid system shutdown. In an embodiment, energy management unit 652 calculates an energy budget for node 204 based on an average energy consumption per task, average energy consumption per unit time, or other metric for node 204, to determine an amount of energy the node, configured as an energy harvesting node, should harvest from a wireless charger node within the network or an amount of excess stored energy that the node, configured as a wireless charger node, can transfer to another node within the network. In at least one embodiment, energy management unit 652 incorporates other functions (e.g., functions described with reference to energy management unit 632).

Referring to FIG. 7, in an embodiment, mobile node 202 or other node of wireless communications network, includes separate integrated circuits for implementing functions of control & data processing circuitry 608, e.g., controller 902 and host 904. In some embodiments, mobile node 202 incorporates functionality of controller 902 and host 904 in a single integrated circuit device. Controller 902 and host 904 execute instructions to implement portions of a wireless communications network protocol stack. For example, controller 902 implements physical layer 906, which includes software that interacts with the RF transceiver (e.g., including a transmitter and receiver). Link layer 914 interfaces directly to physical layer 906 to handle transmission and reception of associated signals. In at least one embodiment, link layer 914 of controller 902 communicates with host 904 via host interface 916. Host 904 implements upper layers of the communications protocol stack (e.g., network layer 918, transport layer 920, and application layer 922). In other embodiments, the layers of the software protocol stack have different distributions between controller 902 and host 904 or are completely implemented using controller 902.

In an embodiment, a gateway node includes an energy harvesting scheduler (e.g., implemented in platform software) that schedules wireless charging sessions when multiple wireless charger nodes are available in a network. The energy harvesting scheduler receives inputs from an energy management unit based on requirements of mobile node 202, or it receives inputs directly from application software for energy-aware applications to schedule wireless charging sessions. The energy harvesting scheduler is aware of registered energy charger nodes and associated availability schedules. The energy harvesting scheduler has sole control of scheduling the wireless charging sessions to meet energy requirements of mobile node 202.

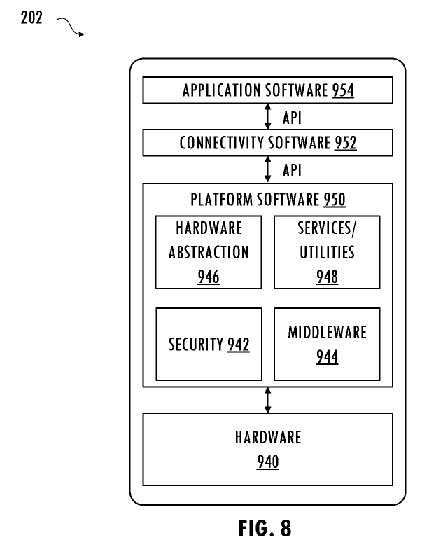

In at least one embodiment, application software need not be modified to support energy harvesting techniques described herein. Rather the energy harvesting techniques described herein are implemented as a platform service (e.g., using an embedded software stack or platform software 950 of the IoT node illustrated in FIG. 8), with the application being unaware of the wireless charging service. In an embodiment, the platform software 950 of an IoT node is a layer of software in the software stack that registers or requests a wireless charging session and encapsulates finer details from the application layer. However, advanced users may tailor the wireless charging service and include variations to application software 954 accordingly, per application requirements. For example, a BLE-based application ensures that mobile node 202 has sufficient energy to support an upcoming wireless charging session. That service may be configurable using an API. An exemplary platform layer includes at least one API that interacts with the hardware but is separate from an any user application. In other embodiments, a user application provides the option to enable or disable a wireless charging session feature. In an embodiment, a platform layer interacts with physical layer 906. In embodiments that include a host and a controller, the host and controller include corresponding platform layers.

Referring to FIG. 8, in some embodiments, an energy harvesting system of mobile node 102 includes hardware 940 and embedded software. For example, hardware 940 includes a processor, memory wireless radio, a radio frequency energy harvesting circuit, energy management circuit, energy storage, I/O, etc. Platform software 950 includes security 942, middleware 944, hardware abstraction layer 946 (e.g., register interfaces, device drivers, real-time operating system), and services and utilities 948 (e.g., timers, wireless charger discovery protocol, energy management unit, and energy harvesting scheduler). Platform software 950 communicates with connectivity software 952 and application software 954 using APIs.

In an embodiment, platform software 950 of a node is a layer of software in the software stack that provides the capability for the node to register and initiate a wireless charging session and encapsulates finer details from the application layer. An exemplary platform layer includes at least one API that interacts with the hardware but is separate from an any user application. In other embodiments, a user application provides the option to enable or disable a wireless charging session feature. In an embodiment, a platform layer interacts with a physical layer (e.g., hardware 940). In embodiments that include a host and a controller, the host and controller include corresponding platform layers.

Thus, techniques for harvesting energy by a mobile device from other nodes in a wireless communications network that include a gateway node to register nodes of the wireless communications network and to assign registered wireless charger nodes to wireless charging sessions requested by registered mobile devices have been described. The techniques reduce power consumption and communications traffic by wireless charging sessions of the wireless communications network as compared to scanning and pairing techniques. The description of the invention set forth herein is illustrative and is not intended to limit the scope of the invention as set forth in the following claims. The terms “first,” “second,” “third,” and so forth, as used in the claims, unless otherwise clear by context, is to distinguish between different items in the claims and do not otherwise indicate or imply any order in time, location, or quality. For example, “a first received signal," and "a second received signal," do not indicate or imply that the first received signal occurs in time before the second received signal. Variations and modifications of the embodiments disclosed herein may be made based on the description set forth herein, without departing from the scope of the invention as set forth in the following claims.

What is claimed is:

1. A method for wirelessly harvesting energy in a network of nodes, the method comprising:
transmitting, by a mobile node in the network of nodes, a request for a wireless charging session, the request including location information for the mobile node; and
receiving from a gateway node in the network of nodes in response to the request, a wireless charging session response including an assignment of a second node in the network of nodes to be a wireless charger node, the second node being proximate to the mobile node and available for the wireless charging session.

2. The method as recited in claim 1 wherein the request further includes a target amount of energy to be harvested and the assignment of the second node is based on the location information and the target amount of energy to be harvested.

3. The method as recited in claim 1 wherein the assignment includes a duration of a wireless charging session and a start time.

4. The method as recited in claim 1 further comprising:
selecting, by the gateway node, the second node of the network of nodes to be the wireless charger node based on the location information for the mobile node; and
sending the wireless charging session response including the assignment.

5. The method as recited in claim 4 further comprising:
initiating the wireless charging session between the second node and the mobile node in response to the wireless charging session response.

6. The method as recited in claim 1 further comprising:
transmitting, by the mobile node, a second request for a second wireless charging session, the second request including updated location information for the mobile node; and
receiving from the gateway node in response to the second request, a second wireless charging session response including a second assignment of a third node in the network of nodes as the wireless charger node, the third node being closer to the mobile node than the second node based on the updated location information.

7. The method as recited in claim 1 further comprising:
sending a registration request by the mobile node to the gateway node,
wherein the request is transmitted by the mobile node after the mobile node sends the registration request.

8. The method as recited in claim 1 further comprising:
transmitting by mobile node, a wireless charger node registration request including a proposed wireless charger node configuration; and
receiving an acknowledgement by the mobile node, the acknowledgment including a wireless charger configuration based on the proposed wireless charger node configuration.

9. The method as recited in claim 1 further comprising:
transmitting by the second node, a charger registration request; and
receiving from the gateway node, a wireless charger registration acknowledgement by the second node.

10. The method as recited in claim 1 further comprising:
receiving from the second node, a wireless energy transfer packet by the mobile node in response to a received energy harvesting session initiation packet.

11. A network of wireless nodes comprising:
a gateway node comprising:
a radio frequency transceiver configured to transmit and receive radio frequency signals; and
processing circuitry configured to execute an energy harvesting service operable to:
register a plurality of wireless nodes; and
assign a first node of the plurality of wireless nodes as a wireless charger node for a wireless charging session in response to a request for the wireless charging session from a second node of the plurality of wireless nodes and based on a location of the second node relative to a corresponding second location for each node of the plurality of wireless nodes, the second node being a mobile node.

12. The network as recited in claim 11 further comprising:
the second node comprising:
a second radio frequency transceiver configured to transmit and receive radio frequency signals; and
second processing circuitry configured to execute a second energy harvesting service operable to:
generate the request for the wireless charging session, wherein the request includes information regarding the location of the second node.

13. The network as recited in claim 11 wherein the gateway node stores registration information for each node of the plurality of wireless nodes, the registration information including identification information and location information.

14. The network as recited in claim 11 wherein the energy harvesting service is further configured to schedule the wireless charging session based on an estimate of energy to be harvested by the second node during the wireless charging session and based on an indication of available energy of each of the plurality of wireless nodes.

15. The network as recited in claim 11 wherein the energy harvesting service is further operable to:
transmit an acknowledgement to the second node in response to a registration request from the second node; and
transmit a wireless charging session response to the second node, the wireless charging session response including an assignment of the first node as the wireless charger node, the wireless charging session response being sent in response to receiving the request for the wireless charging session from the second node, the request including location information for the second node,
wherein the assignment includes a duration of a wireless charging session and a start time.

16. A method for harvesting energy in a network of nodes, the method comprising:
receiving, by a gateway node of the network of nodes, a request for a wireless charging session from a mobile node of the network of nodes, the request including location information for the mobile node; and
in response to the request, transmitting an assignment of a second node in the network of nodes as a wireless charger node based on the location information and proximity of the mobile node to the second node.

17. The method as recited in claim 16 wherein the assignment includes a duration of a wireless charging session and a start time.

18. The method as recited in claim 16 wherein the assignment is further based on a target amount of energy to be harvested by the mobile node.

19. The method as recited in claim 16 further comprising:
receiving, by the gateway node, a second request for a second wireless charging session from the mobile node, the second request including updated location information for the mobile node; and
transmitting by the gateway node in response to the second request, a second wireless charging session response including a second assignment of a third node in the network of nodes as the wireless charger node, the third node being closer to the mobile node than the second node based on the updated location information.

20. The method as recited in claim 16 further comprising:
receiving a registration request from the mobile node and storing the location information associated with the mobile node; and
receiving a second registration request from the second node and storing second location information and wireless charging availability information associated with the second node.
